(19) United States
(12) Patent Application Publication
(10) Pub. No.: US 2023/0054944 A1
(43) Pub. Date: Feb. 23, 2023

(54) WHOLE MUSCLE MEAT SUBSTITUTE AND METHODS OF OBTAINING THE SAME

(71) Applicant: REDEFINE MEAT LTD., Rehovot (IL)

(72) Inventors: Eshcar Ben-Shitrit, Nataf (IL); Alexey Tomsov, Kadima (IL); Daniel Mandelik, Rehovot (IL); Nir Hazan, Rehovot (IL); Nina Bochner, Gan Yavne (IL); Daniel Dikovsky, Ariel (IL); Jonathan Hausner, Kefar Saba (IL)

(21) Appl. No.: 17/774,984

(22) PCT Filed: Nov. 12, 2020
(86) PCT No.: PCT/IL2020/051174

§ 371 Date: May 6, 2022

Related U.S. Application Data
(60) Provisional application No. 62/934,052, filed on Nov. 12, 2019.

(51) Int. Cl. A23J 3/22; A23J 3/26; A23J 3/14; A23L 13/40; A23L 13/60; A23L 33/185

(52) U.S. Cl. CPC A23J 3/227; A23J 3/26; A23J 3/14; A23L 13/426; A23L 13/60; A23L 33/185

(57) ABSTRACT

The present disclosure provides a whole muscle meat substitute and method for its production using additive manufacturing techniques. Specifically, the whole muscle meat substitute comprises one or more layers of digitally printed protein-containing strands, wherein each layer comprises a single convoluted strand or a plurality of strands such that segments between folds of the single strand or the plurality of strands are arranged in an essentially parallel along their longitudinal axis, the strand or strands comprising one or more bundles of axially aligned texturized protein fibers; and wherein at least a portion of the texturized protein fibers comprises elongated fibers having a length above 5 mm. The method disclosed herein comprises operating a digital printer to dispense onto a rinter bed a single convoluted protein containing strand or a plurality of individual protein containing strands, the single strand being folded or the plurality of said strands being arranged such that segments between folds of the single strand or the plurality of strands are essentially parallel along their longitudinal axis.

### TECHNOLOGICAL FIELD

The present disclosure relates to the food industry and specifically to meat substitutes and methods for obtaining the same.

### BACKGROUND ART

References considered to be relevant as background to the presently disclosed subject matter are listed below:
Thomas Lötzbeyer and Anna Knäulein “Towards printing a meat-like structure using sustainable plant proteins” 2016, http://3foodprintingconference.com/wp-ontent/uploads/2016/04/Anna-Kn%C3%,A4ulein.pdf
U.S. Patent Application Publication No. 20170035076
U.S. Patent Application Publication No. 2017164650
International Patent Application Publication No WO2018202852
https://www.dezeen.com/2018/11/30/novameat-3d-printed-meat-free-steak/
Jet Eat Wants to Redefine Meat Through 3D Printing Plants into Steaks” Malisa Gonzales, Jun. 21, 2019 3D Printed Food, https:3dprint.com/247377/jet-eat-wants-to-redefine-meat-through-3d-printing-plants-into-steaks/
US Patent Application Publication No. 2,682,466

Acknowledgement of the above references herein is not to be inferred as meaning that these are in any way relevant to the patentability of the presently disclosed subject matter.

### BACKGROUND

Growing demand for animal free meat products resulted in the increase in different meat substitute products in the market, with the majority of the products comprising of the protein source tofu, tempeh, textured vegetable protein, (wheat gluten) seitan, mycoprotein and other plant based proteins. However, the desired taste, texture and nutritional profile of these products are still to be achieved. Specifically, achieving an edible matrix comprising of fiber structure similar to that of animal meat, with interlaced texture and flavor imparting component is not possible with known production methods.

One barrier towards reaching the goal is to be able to mimic the complex three-dimensional network of fibers and connective tissues within the meat that provides cohesion and firmness and that traps polysaccharides, fats, flavors, colors, moisture and other functional food ingredient, all together providing the textural, nutritional and sensory characteristics of animal meat products.

Towards reaching the goal various technologies have and are still been developed, these including, dry extrusion, high-moisture extrusion, shear-cell, spinning, mixing, micro-extrusion, deposition 3D printing and others.

Anna Knäulein describes in her presentation during a 3D food printing conference held in 2016 at Velno meat replacement products on the market, screening methodology of plant proteins suitable for micro-extrusion in conjunction with a digitally controlled X-Y-Z bed, [Thomas Lötzbeyer and Anna Knäulein “Towards printing a meat-like structure using sustainable plant proteins” 2016, http://3foodprintingconference.com/wp-ontent/uploads/2016/04/Anna-Kn%C3%,A4ulein.pdf].

US20170035076 describes a meat structured protein product comprising cell wall material (including polysaccharides), protein fibers that are substantially aligned, a moisture content and a non-animal protein material. The meat structured protein product is obtained by combining a non-animal protein material, water, and cell wall material to produce a dough; shearing and heating the dough so as to denature the proteins in the protein material and produce protein fibers that are substantially aligned in a fibrous structure; and setting the dough to fix the fibrous structure previously obtained. The process may further involve a post processing step including, inter alia, 3D printing as a means of achieving the desired product shape.

US2017164650 describes a method for producing an edible product comprising an edible powder composition and at least one edible liquid, the edible powder composition comprises a water soluble protein, a hydrocolloid and a plasticizer, and subjecting the composition to powder bed printing by depositing the edible liquid onto the powder in layer-wise manner and thereby obtaining the edible product.

WO2018202852 described food having a fibrous structure comprising at least one vegetable constituent of aquatic origin. The food may be produced by extrusion cooking and/or 3D printing.

Beyond Meat® is a Los Angeles based producer of plant based meat substitutes, founded in 2009 by Ethan Brown. The company developed and manufactures a variety of protein-based food products comprising mixtures of plant based protein (e.g. soy Mung-Bean and pea protein isolates) and other ingredients, which are fed into a food extrusion machine to produce the base for meat substitutes including chicken and hamburger substitutes.

Shortly thereafter, Impossible Foods® introduced a minced beef substitute with the company's signature product, the Impossible Burger® that is based on wheat gluten texturized flakes and flavor components including a synthetic Heme compounds produced by genetically engineered yeasts.

A protein-based product in conjunction with deposition 3D printing shaping was described by Giuseppe Scionti, an Italian bioenginner who established the Spanish startup Novameat®. Novameat describes 3D printing of meat free edible product made from vegetable proteins, which according to Scionti, mimics the texture of beef [https://www.dezeen.com/2018/11/30/novameat-3d-printed-meat-free-steak/]

3D printing of plants into steak was also described by the inventor Jet Eat (Redefine Meat) [“Jet Eat Wants to Redefine Meat Through 3D Printing Plants into Steaks” Malisa Gonzales, Jun. 21, 2019 3D Printed Food, https:3dprint.com/247377/jet-eat-wants-to-redefine-meat-through-3d-printing-plants-into-steaks/]Finally, U.S. Pat. No. 2,682,466 describes a high protein food product, regarded as synthetic meat, and process for its preparation. The process includes preparing a quality of filaments of protein material, applying to the filaments an edible binder and fat. The process also involves, inter alia, stretching of the filaments so as to produce an orientation of the molecules.

### GENERAL DESCRIPTION

The present disclosure provides digitally printed meat substitutes.

In the context of the present disclosure, when referring to digital printing it is to be understood as meaning any form of additive manufacturing that is based on a pre-defined assembly plan.

In accordance with a first of its aspects, the present disclosure provides a meat substitute (meat analogue) comprising one or more layers of digitally printed protein containing strands, wherein
each layer comprises a single convoluted strand or a plurality of strands such that segments between folds of the single strand or the plurality of strands are arranged in an essentially parallel orientation along their longitudinal axis;
the strand or strands comprise one or more bundles of axially aligned texturized protein fibers; and
   wherein at least a portion of the texturized protein comprises elongated fibers having a length above 5 mm.

In accordance with a further aspect, the present disclosure provides a method of producing a meat substitute the method comprising:

introducing into a printer head of a digital printer a protein containing material, either dry or wet, possibly comprising a bundle or several bundles of fibers, the fibers being either axially aligned or arbitrarily oriented; and

operating the digital printer to dispense onto a printer bed a layer of a single convoluted protein containing strand or a plurality of individual protein containing strands comprising texturized protein material, preferably containing fibers within a bundle of fibers axially aligned one with respect to another, the single strand being folded within the layer or the plurality of said strands being arranged within the layer such that segments between folds of the single strand or the plurality of strands are essentially parallel along their longitudinal axis;
wherein the digitally printed protein containing strands comprise texturized protein; and wherein at least a portion of the texturized protein comprises elongated fibers having a length above 5 mm.

The texturized protein comprises or is preferably texturized vegetable protein (TVP)

### BRIEF DESCRIPTION OF THE DRAWINGS

In order to better understand the subject matter that is disclosed herein and to exemplify how it may be carried out in practice, embodiments will now be described, by way of non-limiting example only, with reference to the accompanying drawings, in which:

FIGS. 1A-1B are schematic illustrations of a segment of a strand in accordance with non-limiting examples of the present disclosure.

FIGS. 2A-2C provide illustrations of strand deposition configurations.

FIGS. 3A-3C are images of three different meat substitutes according to the present disclosure, manually spliced across a plane parallel to P printing axis which is the direction of the strands within the meat substitute (scale bar=10 mm).

FIGS. 4A-4B are images of a modified tensile test (FIG. 4A) setup and a modified shear test setup (FIG. 4B) described here.

FIGS. 5A-5C show the separation of fibers by sifts of different mesh size, with FIG. 5A showing fibers on a 1 mm mesh sized sift, FIG. 5B showing fibers on a 2 mm mesh sized sift, and FIG. 5C showing fibers on a 3.2 mm mesh sized sift.

FIGS. 6A-6D are images of isolated TVP fibers of two different types including TVP Supermax 5050 before (FIG. 6A) and after (FIG. 6B) printing, and TVP A1550 fibers before (FIG. 6C) and after (FIG. 6D) printing (scale bar being 50 mm).

FIGS. 7A-7C are images of isolated TVP fibers (TVP A1550) before printing (FIG. 7A), after printing with PCP using a 30 mm rotor (FIG. 7B) and after printing with PCP using a 20 mm rotor (FIG. 7C) (scale bar being 50 mm).

FIG. 8 is a sensory evaluation spider diagram prepared based on a panel of 8 tasters.

### DETAILED DESCRIPTION OF EMBODIMENTS

A good animal-free meat analogue involves the reconstruction of the sophisticated structure of animal muscle with plant-based components.

The present disclosure is based on the development of meat substitutes (also known by the term meat analogues) making use of specifically designed protein-based/protein-containing materials (i.e. formulations comprising proteins) and the use of digital printing (additive manufacturing) principles and techniques.

As will be further discussed below, it has now been found that digitally printing of protein-based material comprising at least a portion of texturized protein provides a whole muscle meat substitute with improved fibrous texture, flavor delivery and taste experience. More specifically, it has been found that the texture of the whole meat substitute is improved when including in the protein component of the product, i.e. in the protein based material, a portion of elongated fibers, as will be further discussed below.

Without being bound by theory, one major contributor to the desired properties is achieved by alignment of fibers within the protein component, as further discussed below. This may be achieved by introducing into or forming within the protein containing material texturized protein, e.g. pre-texturized fibers of plant-based proteins and/or pre-texturized bundles of fibers of plant-based proteins.

In the context of the present disclosure when referring to whole muscle meat substitute (also known in the art by the term whole muscle meat analogue or whole muscle meat alternative) it is to be understood as encompassing a nutritionally and/or culinary desired food product that is essentially animal free (i.e. may contain minority of animal-based ingredients) and has a taste and/or texture and/or other organoleptic properties of whole muscle meat that provides the consumer with an experience that closely matches the eating experience of whole muscle beef, whole muscle pork, whole muscle chicken, whole muscle fish etc.

Further, when referring to whole muscle meat substitute it is to be understood by its plain meaning, namely, an edible product that resembles in taste, texture and/or other organoleptic properties of true meat from animals that has not been ground, chopped or cut other than to provide a particular shape to the meat substitute. This includes, for example, a whole slab and/or a cut of a steak from a whole slab.

Thus, in accordance with a first of its aspects, there is provided a whole muscle meat substitute comprising one or more layers of digitally printed protein containing strands, wherein each layer of the one or more layers comprises a single convoluted strand or a plurality of strands such that segments between folds of the single strand or the plurality of strands are arranged in an essentially parallel configuration along their longitudinal axis; each of the one or more strands comprise one or more bundles of texturized fibers, e.g. axially aligned fibers.

The whole muscle meat substitute comprises one or more layers comprising protein-containing strands. The strand can be a single elongated convoluted strand, or a plurality of strands arranged such that segments between folds of the single strand or segments of strands from the plurality of strands are interconnected one to its neighboring strand at one or more connection points. There could be a single point of connection between neighboring segments or strands or more than one point of interconnection, that are distributed along a portion of a strand's longitudinal axis.

In some examples, the meat substitute comprises at least two layers of the protein containing strand(s), and the two or more layers are interconnected at one or more points along each layer. In another example the meat substitute comprises at least two layers of the strand(s) and at least one more component that contains fat and/or water.

At least some of the protein-based strands may neighbor non-proteinous material, such as fat, food additives, moisture, etc., as further discussed below. Is such case, interconnection as described above may be between the protein-based strands and non-proteinous material, possibly arranged in strands as well.

In the context of the present disclosure, when referring to interconnection between strands it is to be understood as encompassing any form of linkage, including, without being limited thereto, chemical linkage and/or physical linkage. Chemical linkage may include any type of ionic bond, covalent bond, coordinate covalent and metallic bond. Physical linkage may include any type of hydrogen bond and van der Waals forces. In one example, interconnection comprises chemical bonding between functional groups of protein molecules from neighboring strand segments. In one example, the interconnection involves S-S/disulfide bridges between protein molecules from neighboring stand segments. At times, the strands are interconnected by the aid of an edible adhesive and/or by the aid of a physical structure wrapping or otherwise physically holding in place the strands.

In some examples, the strands are essentially uniform in their dimension within a layer of the meat substitute. In some examples, a strand has a length of 1 cm to 100 cm, or at times, 2 cm-50 cm.

For example, when the meat substitute is printed in a form of a slab, the stand may have a length within the range of 10 cm to 100 cm or within any range within this range; while when the meat substitute is printed in a form of a steak, the strand would typically have a length from 1 cm to 5 cm or a length within any range within this range.

In some examples, the strand has a diameter of 50 μm to 5 mm, or at times 200 μm to 5 mm.

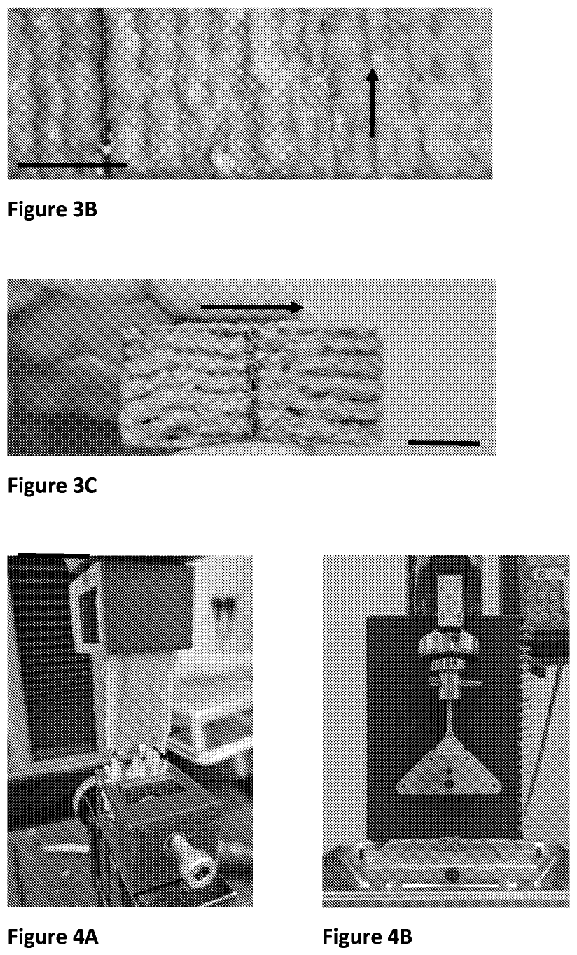

The strands are generally parallel within layers of the meat substitute. This essentially parallel alignment can be considered a unique feature of the whole muscle meat substitute of the present disclosure. The generally parallel alignment can be viewed by the eye or by any imaging technique, such as optical microscope capable of resolving strands of at least 50 μm in diameter. The alignment of the strands is seen, for example in FIGS. 3A-3B (the strand's long axis direction is marked by the black arrows).

Specifically, and without being bound by theory, the parallel arrangement of strands can be absent of voids or gaps between the stands, that would typically appear when strands are digitally printed cross-wise, e.g. as a net or matrix-like structure. The lack of voids or gaps is a result of the manner of printing the stands (in parallel orientation) as well as by controlling the construction of the layers such that the stands are also aligned across the layers, at times, applying negative pressure on the layers (e.g. vacuum) and/or compacting the layers after being printed.

Moreover, and without being bound by theory, the organization of the protein-containing material in the form of elongated parallel strands in the meat substitute mimics the physiological structure of animal muscle, therefore resulting textural attributes that are similar to those of animal-meat.

The protein-containing material in the strand can include any structurally organized (i.e. texturized) form. In some cases, the protein-containing material is present in a form of a plurality of substantially/essentially aligned protein fibers.

When the strands comprise essentially aligned fibers, it to be understood to refer to the fibrous texturized protein which is in the form of elongated fibers having a nominal direction within each strand.

In some other examples, at least part of the protein-containing material in the strand can be present in a form of vesicles.

In some examples, at least part of the protein-containing material in the strand can be present in a form of a polymeric matrix holding the protein-based material.

In some examples, the protein-containing material in the strand can be present in a form of an emulsion and/or dispersion.

In some examples, at least part of the protein-containing material in the strand can be present in a form of a protein-based Gel.

In a preferred case, the strands comprise fibers, possibly organized into bundles, preferably in an essentially axially aligned form as described below. This fibers alignment creates a 2 or even 3 level structural hierarchy (first level defined by the strands alignment, and second level defined by the fibers alignment, and at times, there is an even further level of alignment of filaments within the fibers) that improves even further the resemblance of the whole meat substitute to the physiological structure of animal muscle, and therefore the similarity of their textural attributes.

The existence of distinct strands and fibers and/or bundles of fibers can be viewed when using a microscope, having a magnification of at least ×10, and such bundles are not necessarily evenly distributed within a cross section of a strand.

At times, the fibers within the texturized protein can have a shape of flakes, some being elongated flakes of the texturized protein. At times, the fibers within the texturized protein has rectangular shape. At times, the fibers within the texturized protein are in a form of bulk material. The strands are arranged in an essentially parallel configuration.

When referring to essentially parallel strands it is to be understood to refer to the orientation of at least 50% of the strands, at times, at least 60%, at times, at least 70%, and at times at least 80%, or even 95% of the strands , one with respect to the other when viewed within a portion of a layer such that their longitudinal axis, to be generally parallel. The term “generally parallel” should be understood to encompass the nominal direction of the longitudinal axis to be at most ±10°, at times, at most ±3°, at most ±1°

In the context of the present disclosure, the term “generally” or “essentially” is to be understood to also include some level of deviation (e.g. 1%, 2%, 3%, 10% or even up to 20%) from the defined parameter.

The nominal direction of strands from one layer are generally parallel with the nominal direction of the strands from another layer in the meat substitute. In other words, the nominal direction of strands within a portion of the meat substitute that contains more than one layer is essentially the same, such that not more than 20%, at times not more than10%, at times, not more than 3%, not more than 1% of the strands from one layer cross the direction of the strands from another layer, e.g. its neighboring layer.

The term “nominal direction” refers, in some cases, to a direction where significantly more than 50% of the fibers within the strand have a direction of up to ±45 degrees from that nominal direction, when the strand is viewed from any direction perpendicular to the strand direction.

Yet further, the term “nominal direction” may refer to the average of the fiber's direction as found using high magnification imaging as described herein.

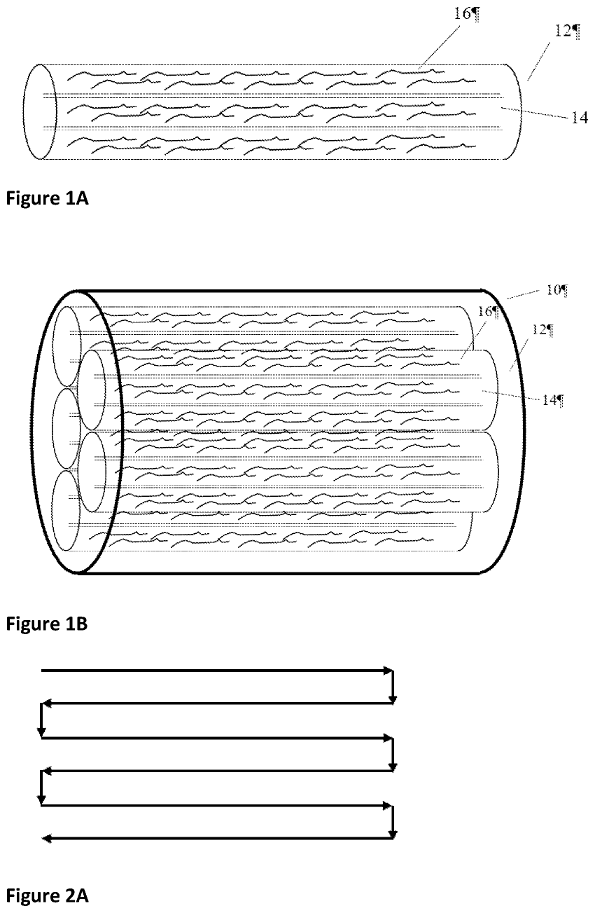

The fibers within a strand can be arranged as a single or a plurality of distinct bundles. In this connection, reference is made to FIGS. 1A and 1B schematically illustrating a meat substitute strand 10, comprising a bundle 12 of essentially axially aligned fibers 14, each fiber comprising structurally organized filaments 16. Specifically, FIG. 1A illustrated that the strand 10 comprises a single bundle 12 of fibers 14 that are essentially distributed along the strand 10; FIG. 1B schematically represents a strand 10 comprising several bundles 12, each comprising essentially aligned fibers and structurally organized filaments.

In accordance some examples, the fibers within the strands are elongated fibers, i.e. that might have been separated from their original bundle structure but have not been completely chopped or otherwise completely reduced in length prior to being mixed within the dough material. This is a distinguishing feature from hitherto known meat substitutes, where extruded protein is chopped prior to formulating and shaping it into the form of a food product. In other words, as further discussed herein, at least part of the fibers are elongated fibers having a length of at least 5 mm. In some examples, at least part of the fibers has a length of at least 6 mm, at times of at least 7 mm, at times of at least 8 mm, at times of at least 9 mm, at times of at least 10 mm.

When the fibers are aligned within a strand, the structural alignment of the fibers can be obtained by methods known in the art, including extrusion of protein containing material, kneading (for example pulling wheat-gluten containing dough), spinning the protein containing material (e.g. wet spinning or electrospinning of protein material), applying shear forces and heat in other ways such as shear (Couette) cell etc., as will be further discussed below.

In some examples, the texturized protein or the fibers in the protein-containing material are sourced from TVP, i.e. the protein-containing material includes at least a portion of TVP and at least a portion of the TVP remains elongated after the 3D printing, with a minimal length of 5 mm.

In some examples, the fibers are sourced from high moisture extruder cooking, HMEC (high moisture extrusion).

In the following, it is to be understood that the description relating to TVP as the texturized protein, also relates to HMEC as an alternative texturized protein.

The amount of elongated fibers in the texturized protein (i.e. with a minimal length of 5 mm and more, as defined above) is also important, and it is required that the strands contain a minimal amount of such elongated fibers.

In some examples, the fibrous material is obtained when using a protein material that comprises denatured protein. Denatured protein can be of the kind obtained by methods known in the art, that would lead to protein denaturation and/or protein filament alignment and creation of fibers. Without being limited thereto, the denatured proteins can be of a kind obtained by applying mechanical forces (e.g. in processes such as: spinning, agitating, shaking, shearing, pressure, application of turbulence, impingement, confluence, beating, friction, wave), radiation (e.g. microwave, electromagnetic), thermal energy (heating—by steam or otherwise), cross-linking, enzymatic reaction (e.g. transglutaminase activity) and chemical reagents (e.g. pH adjusting agents, kosmotropic salts, chaotropic salts, gypsum, surfactants, emulsifiers, fatty acids, amino acids).

The strands of the meat substitute can include a single protein or a combination of proteins. The protein can be from any source or from a combination of sources known and/or available in the food industry, such as in the meat alternative industry, as further discussed below.

In the context of the present disclosure, the protein-containing material, namely the material forming the protein strands comprises at 10% w/w protein, and yet in some preferred examples, the protein component comprises at least 20%, at least 30%, at least 40%, at least 50%, at least 60%, at least 70% or even at least 80% protein material.

In some examples, the protein forming the protein containing material is plant derived (e.g. isolate or concentrate) or comprises plant derived proteins and peptides. Without being limited thereto, the plant source for the protein can be any one or combination of soy, wheat, legume (e.g. pea, chickpea, beans), rapeseed and corn as well as many other plant based protein sources as known in the art.

In some further examples, the protein can be derived from sources other than plants, such as algae, fungi (e.g. yeast), bacteria and microorganisms in general.

In yet another example, at least part of the protein-based material can contain animal derived components, e.g. beef muscle, chicken muscle fibers, insect-based protein powders, etc., or achieved by means of cellular agriculture.

Yet, a preferred embodiment is one that lacks animal derived components (excluding components obtained from cell culture).

In some examples, as also noted above, the protein containing material comprises texturized vegetable protein (TVP). TVP is known in the art to be used as a meat extender or vegetarian meat and is usually created by extruding protein isolates or concentrates using high shear, pressure and heat, from vegetable sources such as wheat, pea and others. TVP is commercially available in different sizes from large chunks to small flaks.

In some examples, the minimal amount of TVP within the protein containing material, as determined before printing, is at least 10% w/w of dry weight TVP, out of the total protein containing material. At times, the minimal amount is at least 15% w/w of dry TVP, at times at least 20% w/w of dry TVP; at times at least 25% w/w of dry TVP; at times at least 30% w/w of dry TVP; at times at least 35% w/w of dry TVP; at times at least 40% w/w of dry TVP; at times at least 45% w/w of dry TVP; at times at least 50% w/w of dry TVP; at times at least 55% w/w of dry TVP; at times at least 60% w/w of dry TVP.

In some examples, the minimal amount of TVP within the protein containing material, as determined before printing, is at least 20% w/w of wet TVP out of the total protein containing material; at times, at least 30% w/w of wet TVP out of the total protein containing material.is at least 35% w/w of wet TVP out of the total protein containing material. At times, the minimal amount is at least 40% w/w of wet TVP; at times, at least 45% w/w wet TVP; at times, at least 50% w/w TVP; at times, at least 55% w/w TVP; at times, at least 60% w/w TVP; at times, at least 65% w/w TVP; at times, at least 70% w/w TVP; at times, at least 75% w/w TVP.

The protein-containing material does not include only TVP. In some examples, the protein containing material contains at least 30% non-TVP protein matter.

As times, the amount of elongated fibers can be determined in the final product by taking a mass of the strands from the whole muscle meat substitute (after printing but before frying or cooking), isolating the fibrous material from the protein dough, e.g. by suspending in water until a slurry solution is formed, and filtering the slurry solution through a sift having mesh diameter of 3 mm or 4 mm. Before weighting, the material is squeezed to remove excess of water or dried before weighting. A comparison of the weight of the isolated strands mass before forming the slurry and that of the filtered mass (after removing the water) allows to determine the % weight of the elongated fibers. It should be noted that the elongated fibers may contain non-TVP material adhered to the TVP, such as, gluten.

Notably, other methods may also be applicable for isolating or separating the texturized protein, or the fibers containing the TVP, such as washing with a basic or acidic solution or manual sorting the elongated material, or any other method as known to those versed in art.

In some examples, the protein containing material comprises gluten, which is known to form fibrous structure in its native form, by plain hydration. Without being bound by theory, such gluten-based fibers may be aligned into a certain direction by pulling or pushing through a printing nozzle.

One possible recipe for preparing such protein containing material is using dry texturized vegetable protein (TVP) flakes, soaking it with water at a ratio of 1:3-4 for an hour, squeezing the water, separating the fibers from each other using a soft blade mixing, adding other ingredients and mixing to homogeneous paste.

In some cases, the dough formulation/recipe contains 50% water and 50% dry powders, including:

Powdered Gluten—43.4% (of dry ingredients)

Powdered soy protein—10.6%

Texturized vegetable protein—30.1%

Hydrocolloids—1.1%

Fat—11.9%

Other additives—2.9%

In some examples, the protein component is free of fat or contains not more than 15% (w/w) of fat.

The meat substitute may include components, other than the protein-based material.

In some examples, the meat substitute comprises fat that is not part of the protein component. In the context of the present disclosure, the term “fat component” is to be understood as a component within a segment or a weight unit of the meat substitute that comprises not less than 20%, preferably not less than 30% fat as compared to other non-fat substances within the analyzed segment or weight unit. The fat component is not the protein component and is easily distinguished from the protein component.

In some examples the whole muscle meat substitute comprises a fat-analogue component, i.e. while it does not comprise fat per se, there is a component replicating the texture and flavor imparting aspect of animal fat tissue that is introduced. Such component can be comprised of protein, hydrocolloids, starches, water and possibly fat at low concentrations. Thus, when referring to fat component, it should be understood as also encompassing fat analogues.

The fat component can be plant derived, typically, vegetable derived fat is a food grade oil, fat or triglyceride, and is collectively referred to herein as fat component.

Fat component in the context of the present disclosure can be any fat component as described in International patent application publication No. WO 2020/152689 the content of which is incorporated herein in its entirety.

The fat component can constitute a layer within a multi layer slab, and/or constitute a segment or portion of a layer of the meat substitute.

In some cases, the fat component is disposed between adjacent layers in a multi layered meat substitute (e.g. layers of a meat slab).

The meat substitute typically also comprises a water-based component. In the context of the present disclosure, when referring to “water-based component” or “moisture providing component” it is to be understood as encompassing substances dissolved in water or in a water containing gel, or water-based emulsions.

In some examples, the water-based component holds one or more polysaccharides and derivatives thereof. Without being limited thereto, the one or more polysaccharides may include starch, pectin, agar, carboxymethyl cellulose, carrageenan, alginate, xanthan gum, guar gum, locust bean gum etc.

In some cases, the polysaccharides or derivatives thereof are of a type that in the presence of water form a gel. Thus, the water component present in the meat substitute, in accordance with some embodiments, is a gel-based component.

In some examples, the water-based component comprises substances known to be used for imitating the flavor of mouthfeel of blood, for example, myoglobin.

In some examples the water-based components can be or include animal blood, or animal blood-like component achieved by means of cellular agriculture.

In some examples, the water-based component comprises fat, e.g. emulsifiers.

In some examples, the meat substitute comprises a combination of protein based component (preferably animal free), fat component (preferably animal free), and water based component (which preferably includes a function of a connecting component, binding together the protein based component strands and/or fat based component strands). In some examples, there is also a binding element that can be an integral part of the water based component or a distinct component regardless of whether the meat substitute comprises or doesn't comprise a water based component as well. In addition, it is possible to add a polysaccharide film that may act as a connective tissue.

Each of the components may include other edible additives, such as, without being limited thereto, colorants (e.g. annatto extract, caramel, elderberry extract, lycopene, paprika, turmeric, spirulina extract, carotenoids, chlorophyllin, anthocyanins, and betanin), emulsifiers, acidulants (e.g. vinegar, lactic acid, citric acid, tartaric acid malic acid, and fumaric acid), flavoring agents or flavoring enhancing agents (e.g. monosodium glutamate), antioxidants (e.g. ascorbic acid, rosemary extract, aspalathin, quercetin, and various tocopherols), dietary fortifying agents (e.g. amino acids, vitamins and minerals), preservatives, stabilizers, sweeteners, gelling agents, thickeners and dietary fibers (e.g. fibers originating from citrus source)

It is to be appreciated that the composition of each of the protein containing component, the fat component and the water based components as well as any other component (e.g. binding component) may vary within a layer, and may vary in between layers, such that portions of a single layer or several layers or of the entire slab or steak may contain different protein components, different fat components as well as different water based components.

The meat substitute can contain different amounts of the different components so as to provide different portions of the meat substitute with a different mouthfeel or experience.

Yet, in accordance with some examples, a weight unit of the meat substitute, e.g. a 1 kilogram weight unit, may contain the different components in the following respective ranges:

animal free protein containing components (i.e. the protein strands portion) in a weight% amount of between 15% and 40% out of the total weight of the meat substitute.

fat components in a weight% amount of between 5% and 20% out of the total weight of the meat substitute.

water component in a weight% amount of between 50% and 80% out of the total wet weight of the meat substitute.

The whole muscle meat substitute can be in the form of a single slice, or wafer like, disc or plate like, e.g. containing a single or very few layers, or may be in the form of a slab comprising a plurality of stacked layers.

In some cases, the layers can be viewed by camera, optical microscope, scanning electron microscope, preferably environmental scanning electron microscope.

In one preferred example, the whole muscle meat substitute is in a form of a slab.

According to certain examples, to obtain the single or multi-layer meat substitute, there is a use of two principle processes, that not necessarily need to be performed in conjunction (i.e. one immediately after the other). A first principle process comprises providing a protein containing material having a portion of protein filaments, which are denatured and textured, e.g. arranged into protein fibers.

The second principle process comprises digitally printing a strand of the protein containing material, at least a portion of the protein-containing material therein comprising texturized protein, such as TVP or HMEC, with at least a portion of the texturized protein being in a form of elongated fibers having a length of at least 5 mm; onto a printing bed in a manner that a single convoluted strand is folded or a plurality of individual strands are disposed onto the printing bed with segments between folds of the single strand or between the plurality of strands being essentially parallel along their longitudinal axis. In this manner and in accordance with principles of digital printing, a multiplicity of monolayers of strands are formed into a 3D meat substitute.

According to other examples, the first principle process comprises providing a protein containing material where at least a portion of the protein filaments are denatured and are textured, e.g. arranged into arbitrarily oriented protein fibers, e.g. mechanically and/or chemically and/or thermally disintegrated from TVP; and at least a portion of the TVP include elongated fibers with a length of at least 5 mm. The second principle process comprises digitally printing a strand of the protein containing material onto a printing bed in a manner that: (i) the arbitrarily oriented fibers are becoming axially aligned along the strand direction, and (ii) a single convoluted strand is folded or a plurality of individual strands are disposed onto the printing bed with segments between folds of the single strand or between the plurality of strands being essentially parallel along their longitudinal axis. In this manner and in accordance with principles of digital printing, a multiplicity of monolayers of strands are formed into a 3D meat substitute.

According to other examples, to obtain the single or multi-layer meat substitute, there is use of two principle processes, that not necessarily need to be performed in conjunction (i.e. one immediately after the other).

A first principle process comprises providing a protein containing material comprising gluten protein filaments in their native form yet forming arbitrarily oriented gluten-based fibers together with texturized protein, e.g. TVP, at least a portion of which being elongated fibers of at least 5 mm.

The second principle process comprises digitally printing a strand of the protein containing material onto a printing bed in a manner that: (i) the gluten based fibers are becoming axially aligned along the strand direction, (ii) a single convoluted strand is folded or a plurality of individual strands are disposed onto the printing bed with segments between folds of the single strand or between the plurality of strands being essentially parallel along their longitudinal axis. In this manner and in accordance with principles of digital printing, a multiplicity of monolayers of strands are formed into a 3D meat substitute.

All of the above examples may be used either individually or in any combination of more than one example.

The whole muscle meat substitute disclosed herein was evaluated for its physical and organoleptic properties. These included, inter alia, different strength properties as well textural properties.

In some examples, the whole muscle meat substitute was evaluated for its tensile strength as determined by a specifically designed tensile strength test (See for reference FIG. 4A). In the context of the present disclosure, when referring to a “Tensile strength test” or “Modified tensile test” it is to be understood as a test performed by gripping a specimen of the whole meat substitute, having dimensions of 50*20*10 mm (cut from a printed slab of 10 cm*10 cm), between grippers having a contact area of 10*20 mm; and stretching the gripped specimen at a velocity of 20 mm/s and measuring the force and calculating the stress accordingly. The tensile strength represents the maximal stress recorded during the test. The test is conducted at 23° C.±2° C. Specimens of different dimensions may be used depending on the whole muscle meat substitute, e.g. on a steak like substitute, the above procedure will be adjusted accordingly.

Due to the anisotropic properties of the meat substitute, the tensile strength varies depending on the direction of measurement the sample, e.g. when the stretch is parallel to the direction of printing, i.e. parallel to the directions of the strands (“P direction”) or perpendicular to the direction of printing but parallel to the plane formed by the strands of a single layer (e.g. “XP direction”).

In some examples, the tensile strength as determined herein is at least 0.02 MPa when measured parallel to the P direction.

In some examples, the tensile strength as determined herein is at least 0.03 MPa when measured parallel to the P direction.

In some examples, the tensile strength measured as determined herein in the P direction is at least 50% higher than the tensile strength measured under the same conditions in the XP direction.

In some examples, the tensile strength of the meat substitute is defined by a first modified tensile strength value measured in a P direction that is parallel to the strands nominal direction and a second modified tensile strength value measured in the XP direction that is perpendicular to the strands nominal direction and parallel to a layer's plane, wherein said first modified tensile strength value is at least 50% higher than the second modified tensile strength value.

In some examples, the whole muscle meat substitute was evaluated by a shear resistance test specifically designed herein (see for reference FIG. 4B). Therefore, when referring to “shear resistance test” or “modified shear resistance test” it is to be understood as a test performed using a blunt metal blade attached to a Lloyd standard Perspex insertion AACC 16-50 (catalogue number FG/PNB). The blade is in the shape of a trapezoid having a large base 11.81 cm and a small base of 4.44 cm. During the test the upper fixture with the blade is positioned 25 mm above a metal base and a specimen of the size of 20 mm*20 mm*20 mm (8 cm³) is placed underneath in the desired orientation. Then the upper fixture travels 24 mm downwards at 20 mm/s, so it shears the specimen until reaching 1 mm above the metal base plate. The max load is recorded, and the data is then analyzed as desired.

Due to the anisotropic properties of the meat substitute, the shear resistance varies depending on the direction of the sample, e.g. when the blade is directed parallel to the long axis of the strands (i.e. the nominal direction of the strands), also considered as the direction of printing of the meat substitute, i.e. parallel to the direction of the strands (P direction) or perpendicular to the direction of printing (e.g. XP direction).

In some examples, the max load of the shear resistance test when measured in the XP direction is 10N, at times, at least 11N, or even at least 12N.

In some examples, the max load of the shear resistance test when measured in the P direction is at least 100% higher than that when measured in the XP direction.

In some examples, the whole muscle meat substitute is defined by having a first modified shear resistance value that is measured in a direction parallel to the strands nominal direction and a second modified shear resistance value that is measured in a direction perpendicular to the strands nominal direction and parallel to a layer's plane, wherein said second modified shear resistance value is at least 100% greater than the first modified shear resistance value.

Thus, the present disclosure also provides a method of producing a meat substitute the method comprising:

introducing into a printer head of a digital printer a protein containing material comprising fibers, either arbitrarily oriented or axially aligned; and

operating the digital printer to dispense onto a printer bed a single convoluted strand or a plurality of individual strands comprising texturized protein material, e.g. having the fibers within a bundle of fibers axially aligned one with respect to the other, the single strand being folded or the plurality of said strands being arranged such that segments between folds of the single strand or the plurality of strands are essentially parallel along their longitudinal axis;
wherein the protein containing strands prior to printing comprise at least 10% w/w dry texturized protein (e.g. TVP) or at least 20% w/w wet texturized protein, out of a total amount of said protein-based material; and

wherein at least a portion of the texturized protein comprises elongated fibers having a length above 5 mm.

In some cases, the protein containing material (i.e. the protein containing dough) comprises a priori axially aligned fibers.

The texturized protein containing material with the axially aligned fibers can be provided in various manners and using various devices that can provide the defined texturized fibrous protein material. Such devices are referred to herein by the term “texturizer”.

In some cases, the texturized protein containing material is obtained by subjecting un-texturized protein containing material to a texturizer that applies shearing forces, heating and potentially high pressure on the un-texturized protein containing material. Shearing can be achieved by any means known in the art, including extrusion, spinning or shear cell (Couette cell), as discussed above.

For example, and without being limited thereto, protein containing material can be extruded via a screw extruder. This screw extruder may be a type of small-scale extruder that is commonly used (at large scale) to texturize protein into substantially aligned fibrous-texturized protein. Without being bound thereto, a formulation is introduced into a barrel equipped with a screw or with two screws that apply shear on the formulation while increasing its pressure as it travels inside the barrel. The formulation is heated in the barrel by a heater, and then possibly enters a taper, which possibly creates a laminar flow. Then it enters a cooling die, which cools the heated formulation while maintaining its flow in laminar state, thus allowing the further creation of fibrous structure.

For example, and without being limited thereto, the texturizer can be a protein spinner, such as an electrospinning device. A spinner can be used online by using a distributed spinning system constructed of multiple spinners, their outcome being fed directly (or possibly via a “buffer container”) into the printhead. The spinner can be also an offline facility that creates a bundle of texturized muscle component (i.e. pre-texturizing the proteins outside the printing system), using the same conceptual approach as for the off-line prepared strand by extrusion. In some cases, the off-line prepared strands can be packed for storage.

The shearing of the protein material so as to obtain the texturized protein dough is typically, yet not exclusively, at a temperature of between 0° C. and 170° C., at times between 100° C. and 170° C.

The texturized protein containing material can be obtained by combining therein commercially available texturized protein material, e.g. texturized vegetable protein flakes, or can be obtained as products of HMEC (high moisture extruder cooking) or be obtained by any of the methods described above in connection with denatured protein material.

In some examples, the printer may contain, as an integral part thereof, one or more texturizers, where each texturizer is connected to, or even part of, one or more print heads. A few texturizers may share the same components. For example, if the texturizer is a screw, one barrel may be connected to a few cooling dies, one heater may serve a few texturizers, etc.

Using a texturizer during printing can be advantageous over off-line prepared texturized protein material dispensing as used commonly at the 3D food printing (usually utilizing a syringe mechanism). The texturizer performing the protein texturization just before it is printed, allows the printer to easily dispense protein-containing material with high values of chewiness, hardness, gumminess, firmness, toughness and cohesiveness, and substantially aligned fibrous structure which is hard to dispense using a simple syringe.

Using the texturizer allows flexible tuning of the various texturization parameters, such as temperature, pressure, shear rate and extrusion rate, and therefore adjusting the characteristics of the dispensed texturized protein-containing material.

The tuning of texturization parameters may be carried while printing, therefore obtaining products with different or non-uniform texturization and better capability of mimicking animal-based meat products, which typically are not homogenous.

There may be texturization mode switch between different products, allowing printing products with different texture, possibly using the same protein-containing material.

The preparation of the protein containing material with the fibers can be in line, such that the texturized protein containing material is prepared and directly fed into a printer head to be deposited onto the printing bed. Notably, the deposition onto the printer bed can be from a single printer head or from an array of printer heads, each being fed with the protein containing material.

The preparation of the protein containing material with the axially aligned fibers can also be off-line, such that the protein containing material thus prepared is collected into a dedicated collecting container or buffer volume, prior to being fed into the printer head.

When referring to preparation off-line, the preparation process, such as the shearing, pulling or extrusion processes can be at a physical location remote from the digital printer, and then be linked to the printer head via a dedicated port; or the shearing, pulling or extrusion processes and the collecting into a container or buffer volume can be in fluid communication with the inlet of the digital printer head.

Irrespective of whether the protein containing material is prepared on line or off-line, it is expelled/dispensed from the printer head such that the nominal direction of the bundle of fibers within the protein containing material is aligned with the direction of flow of the protein containing material through the printer head, i.e. with the nominal direction of the dispensed strands.

In one example, the processing of the protein material into a protein containing material causes fibrous protein material to reorganize into a bundle or bundles of essentially aligned fibers.

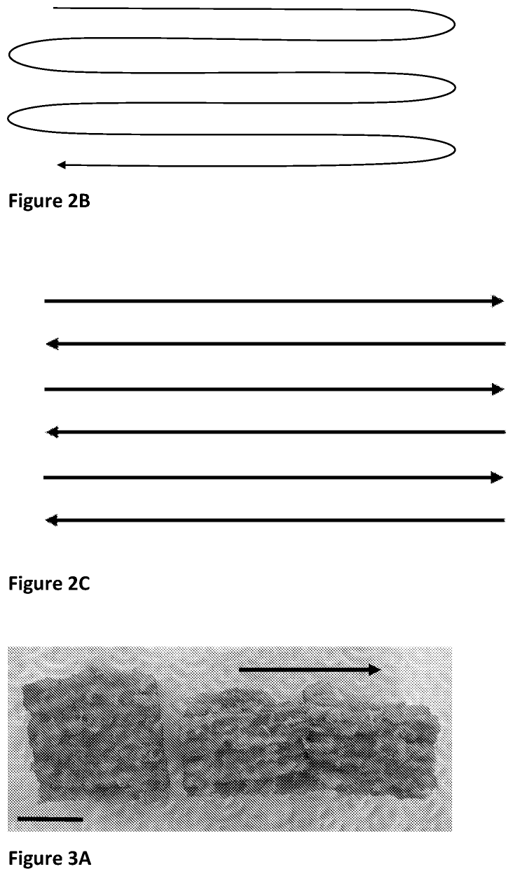

The protein containing material is introduced into one or more printer heads and dispensed onto a printer bed. The protein containing material can be ejected as a single elongated strand forming an entire horizontal/monolayer, e.g. in a zig-zag manner or an accordion manner, as illustrated in FIGS. 2A-2B, respectively. Alternatively, the protein containing material can be ejected from the printer head at non-continuous manner so as to form individual strands, as illustrated in FIG. 2C.

According to the method disclosed herein, the protein containing material is dispensed onto the printer bed such that printed strand is in general contiguous with protein matter already disposed on the bed. As a result, segments between folds of a single strand in a monolayer or individually printed strands are essentially parallel along their longitudinal axis.

The method disclosed herein may further comprise manipulating the dispensed strands or segments of the single strand to interconnect. Such manipulation may include applying physical energy onto at least a portion of a printed strand or strands or applying a reagent that causes the interconnection.

Physical processes causing interconnection may include thermal energy, radiation energy, drying, Cooling, wetting, applying press, acoustic energy.

Reagents may include hydrocolloids, starches, protein isolates or concentrates, carrageenan, guar gum, alginic, grain flour mix, agar, carboxymethyl cellulose, gluten, pectin, locust bean gum, xanthan gum, and polysaccharide and enzymes (such as transglutaminase)

In some cases, the dispensed strand(s) is allowed to rest prior to applying a subsequent layer thereon. The resting may be at a cooled environment, e.g. at any temperature between 0° C. and below room temperature, or at times at controlled temperatures such as about 4° C.

The digital printer is operated also to control various parameters that may affect the properties of the meat substitute. These include, without being limited thereto, temperatures, pressure, rate of dispensing, inner diameter of the printing nozzle, length of the printing nozzles or channel in which material passes.

In some cases, texturizing the protein may be done also after being dispensed onto the printing bed. This can be achieved for example, by chemical or enzymatic cross-linking (gelation).

Also, post treatment such as heating or cooling of a partially texturized product after being fully printed, may be applied as well, to improve e.g. texture parameters, bonding between strands of the same and/or different layers, thus possibly contributing to the texture of the meat substitute.

In some cases, the printer is operated with the following one or combination of parameters: pressure: up to 60 bar; nozzle dimension: 0.1-10 mm; production rate: preferably 5-300 mm per second per nozzle.

In some cases, the protein containing material is specially prepared to be suitable for printing at a narrow nozzle, at times between 0.1 mm to 5 mm, at times between 0.3 mm and 5 mm, at times between 1 mm and 5 mm, where the nozzle aligns the protein fibers or nutritional fibers within the dough as it is being printed, so strands with axially aligned protein fibers are created.

At minimum a system for preforming the method of producing the meat substitute system comprises a digital printer equipped with a printer head including a nozzle for dispensing onto a printer bed at least the, texturized protein (preferably animal free) material and a control unit for controlling operation of the digital printer. More specifically, the printer head is configured to receive the protein based material comprising the minimal amount of texturized, fibrous, protein containing material, having a minimal length, with the direction of flow of the protein based material through the nozzle.

The controller is configured to cause dispensing of at least the protein based material onto the printer bed in a form of an essentially single convoluted strand (essentially single strand being understood as one that may have artifact breaks along the strand and/or the strand may change its composition from segment to segment so as to include along the strand different components) or in the form of a plurality of shorter such strands with segments between folds of the single strand or of the plurality of strands being arranged in an essentially parallel configuration along their longitudinal axis.

The system is also configured to dispense other components, such as a fat containing component, a water based component and other substances either through the same printer head that dispenses the protein dough or through other applicators, such as one or more other, specifically dedicated printer heads, spraying units, etc.

The printer head outlet or nozzle(s) may have different dimensions and shapes. In accordance with some examples, the printer head and its nozzle(s) used for at least dispensing the protein containing material is selected to achieve a specific throughput, e.g. 1 kg-100 kg/hour, more typically 2 kg-50 kg/hour, more typically 5-20 kg/hour. 10 kg/hour will typically require a head with 5-200 nozzles, more typically 10-100, more typically 20-50 nozzles of 2 mm in diameter.

This is roughly scaled with throughput (e.g. twice the throughput will require twice the number of nozzles, for the same inner diameter and dispensing rate of a single nozzle), and with the square of the nozzle inner diameter (e.g. 1 mm inner-diameter nozzles will require ×4 number of nozzles w/r to 2 mm diameter nozzles, in order to maintain a certain throughput).

The system may also comprise a texturizer which receives protein containing material and processes the protein material into the desired protein dough. The texturizer can be in line, namely, it is configured to continuously receive protein material, and discharge the thus formed texturized protein into the printing head.

In some examples, the system is constructed to have two or more printer heads for dispensing simultaneously or in an a priori designed sequence the protein containing and/or the other components, the operation of which is controlled by the controller.

The system may also comprise any one or combination of user interface including input module for introducing input data, inter alia, dictating the composition of each layer in the meat substitute and/or input data regarding conditions of operation including temperature, printing speed; display module for displaying, inter alia, parameters associated with the thus formed layers; a processor for receiving, inter alia, input data associated with the thus formed layers and providing output data regarding quality of the thus formed layer; and memory module for storing data. All such modules are well known in the art of digital printing and therefore need no further elaboration.

The system may include a blade or other cutting mechanism in order to cut the dispensed structured protein-containing material, when the printing is suspended (until printing the next strand or at the end of the product printing). This is particularly required in case of a fibrous protein structure, which doesn't break spontaneously/easily when the printing is suspended.

In some examples, the system comprises the texturizer upstream to the printer head such that the protein containing material thus formed is fed directly into one or more printer head. In some examples, the printer head is an auger printer head. In some other examples, the printer head is a progressive cavity pump (PCP). In yet some other examples, the printer head is based on a piston valve or positive displacement pump.

A preferred printer head is one including a PCP which has been shown herein to provide a superior texture profile over other printer heads, such as Auger type printer head, by having the least damaging effect on the volume/amount of elongated fibers in the expelled strands.

The protein containing material can be stored within a cartridge that is configured to be mounted onto the printer head via a dedicated port. The mounting of the cartridge onto the digital printer head may be such that the cartridge outlet is in flow communication with digital printer head and allows the direction of flow of the protein material from the cartridge to cause alignment of the fibers along the direction of flow of the protein containing material within the printer head and through the printer nozzle. In other words, the nominal direction of the axially aligned fibers expelled from the printer nozzle would be parallel to flow of the protein containing material when expelled thought the cartridge outlet and into the printer head.

The protein containing material within a cartridge may be solid and/or semi-solid (paste-like), wet and/or dry. The protein containing material may be softened in order to easily dispense it and possibly to make it more prone to adhere to neighboring strands. The softening may be achieved by means of wetting, moisturizing, dissolving, melting or any other way known in the art. Accordingly, the softening may be achieved by a dissolvent sprayer (preferably water) or injector, a heater, a laser, or any other unit.

The solid and/or dry material may be stored within a cartridge as a few elongated sticks, placed during the printing process on the printing bed one after the other (or in groups) in a discrete manner, to form the meat substitute.

After dispensing, protein containing material may be hardened, dried or solidified by means of drying, cooling, heating or using chemical agent. Preferably, the protein containing material is dried or cooled without intervention, at room temperature.

In some cases, the protein containing material may be flexible and therefore stored in a rolled or folded manner in the cartridge or may be solid and stored as a few elongated sticks. Other types of storage may be also used.

The method and system disclosed herein are configured to provide a slice/plate/wafer like piece of digitally printed meat substitutes, the slice comprising a single layer of the digitally printed strand or strands, as described herein.

Yet, the method and system disclosed herein are preferably used for digitally printing a meat slab comprising a multiplicity of the digitally printed layers. Such slab may then be cut into slices of different thicknesses and for providing an experience of a steak, the slices of the slab would preferably be cut in a direction essentially perpendicular to the direction of the strands within the slab. The resulting slices which are different from a slice obtaining directly from printing also forms part of the present disclosure. In such slice, being cut from a printed slab, the ratio between the strands' length (after cutting) and slice width (the latter being defined as the smallest dimension of the slice) is approximately 1:1. This is opposed to what is known in the art of digitally printed slice-like products, where the ratio of strand length to slice width is significantly larger than 1:1. Such slice cutting, and especially if the strands contains bundles of axially aligned protein fibers, contributes to mimicking the physiological structure of animal muscle and thus increases the chances of similar texture and mouth feel to that of animal meat.

The dimensions and spatial configuration of the printed whole muscle meat analogue, be is a wafer, a slice of a slab, can be defined by the directions of printing which correspond also to the direction of the essentially aligned strands. Thus, for example, an alternative meat slab as disclosed herein can be defined using spatial dimensions, taking into consideration its length axis, referred to as the P axis and is the axis parallel to the nominal direction of the strands in each layer, the height axis, also referred to as the Z axis, which is perpendicular to the strands layer (strands plane) and the width axis, also referred to as the XP axis, which is perpendicular to the nominal direction of the strands and yet within the plane or parallel to the plane of the strands' layer. For further illustration, reference is made to International patent application publication No. WO 2020/152689 the content of which is incorporated herein in its entirety.

Based on the dimensions of the three different axes, a slab disclosed herein can be defined as a small slab, medium slab or large slab.

For example (numbers refer to cm):

| Slab dimensions | L | h | W |
|---|---|---|---|
| Small | 5-30 | 5-10 | 8-12 |
| Medium | 10-50 | 10-15 | 12-20 |
| Large | 30-100 | 15-30 | 20-40 |

Accordingly, when defining a steak dimension, one refers to its length, height, and width dimensions. Specifically, a steak is typically cut from a meat slab perpendicularly to the P axis such that it has the same width and height of the slab from which it is cut, but the length value (i.e. the steak thickness) would typically be 0.5-10 cm, irrespective of whether the slab was a large, medium or small slab.

When the whole muscle meat substitute is a steak, the P direction is the direction of the strands (which is not necessarily the long axis of the printed product, as in a slab).

### NON-LIMITING EXAMPLES

The following provides non limiting examples for protein-based component, fat-based component and water-based component.

### Protein Component with Disintegrated TVP Fibers

Composition:

TABLE 1
protein component containing TVP

| Component | % - Example 1 | % - Example 2 |
|---|---|---|
| Gluten | 34.06 | 34.06 |
| Soy protein isolate | 18.22 | 18.22 |
| TVP supromax 5010 | 23.86 | 0 |
| Typ. Size 1-2 cm | | |
| TVP supromax 5050 | 0 | 23.86 |
| Typ. Size 3-5 cm | | |
| Givaudan flavor mix | 6.51 | 6.51 |
| Beet color | 1.74 | 1.74 |
| Palm kern oil | 5.42 | 5.42 |
| Beef flavor fat | 5.42 | 5.42 |
| Lecithin | 0.43 | 0.43 |
| Citrus Fibers F7000 | 4.34 | 4.34 |
| Total (without water) | 100.00 | 100.00 |

Water was added as 2.17 grams water per 1-gram dry components

Process of Preparation:

Soaking the TVP in water for at least 2 hours

Squeezing the TVP

Insert the TVP into food processor (non-cutting blade), aggressive mixing until disintegrating TVP fibers.

Inserting the rest of the powder ingredients, and continue mixing

Adding the fat (as liquid) and water and continue mixing, to uniform mass at medium viscosity

Printing using an Auger type printer head equipped with 1.55 mm diameter nozzle at rate of 0.5 Liter/hour

Post-Process Handling

Heat treatment (sous-vide or steam oven) at 80°-90° C. for 45 min.

Cutting into 2 cm slices

Frying on a strip pan, one minute or two on each side.

Results

A distinct Meat-like fibrous texture was exhibited for both Examples 1 and 2.

Example 2 (using TVP 5050) had better texture (more fibrous, better hardness of bite), probably since it contains longer protein fibers compared to 5010

### Protein Component Based on Gluten (without Disintegrated TVP Fibers)

Composition

TABLE 2
protein component containing gluten

| Component | % - Example 1 |
|---|---|
| Gluten | 43.38 |
| Soy protein isolate | 26.25 |
| Nut. Yeast | 13.02 |
| Palm kern oil | 11.93 |
| methyl cellulose | 1.08 |
| Sodium Alginate | 1.74 |
| Lecithin | 0.43 |
| Chia | 2.17 |
| Total (without water) | 100.0 |

Water is added as 2.17 grams water per 1-gram dry components

Process of Preparation:

Inserting the powder ingredients into food processor and mix

Adding the fat (as liquid) and water and continue mixing, to uniform mass at medium viscosity

Printing with an Auger type printer head equipped with a 1.55 mm diameter nozzle at rate of 0.5 Liter/hour

Post-Process Handling

Heat treatment (sous-vide or steam oven) at 80°-90° C. for 45 min.

Cutting into 2 cm slices

Frying on a strip pan, one minute or two on each side.

Results

The resulting printed product had an omelet like texture, with very little fibers and it was thus concluded that the presence of texturized protein is important.

### Protein Component Based on Small TVP Flakes/Chopped TVP

Composition

TABLE 3
protein component containing TVP flakes

| Component | % |
|---|---|
| water | 59.91 |
| Texturized protein | 16.00 |
| Small/chopped to 0.3-0.6 cm | |
| Methylcellulose | 3.00 |
| Chopped onion | 3.00 |
| Flavor mix | 4.04 |
| Brown color natural extract | 0.5 |
| red color natural extract | 0.5 |
| Palm fat | 13.05 |
| Total (w.b.) | 100.00 |

Process of Preparation:

Add the water to the texturized proteins and colors

Mix and leave to rest for 15 min

Add the rest of the ingredients to the mixture

Mix for 3 minutes at medium mixing speed (food mixer)

Printing with an Auger type printer head equipped with a 1.9 mm nozzle diameter at rate of 0.5 Liter/hour

Post-Process Handling

Bake in the oven, 7 min 120° C.

Vacuum seal and store at 4° C.

Pan-fry in vegetable oil for 2-3 minutes on each side, medium heat.

Results

The result resembles in many ways meat kebabs—fatty minced meat texture (the fat is spread homogenously in solid chunks through the product). The resulting product was also aromatic and flavorful. At several tastings—all samples of this example were generally favorable.

### Protein Component Based on Elongated TVP

Composition

The basic protein dough (PD) was prepared by mixing in a standard domestic mixer 15% gluten (vital wheat gluten by Sorpol), 60% tap water, 5% canola oil (‘Shufersal’), 5% red spice colorant (‘Texturot’). This basic protein dough was also used for printing the reference slab.

Two types of texturized protein-based component were produced by combining the protein dough (PD) with 15% of textured vegetable protein (TVP SUPRO MAX 5010 IP, or Supermax 5050, or TVP A1550) gently disintegrated to obtain elongated fibers and ribbons of about 10 mm length in average and having either a thickness of about 1-4 mm (PD-TVP1) or of about 5 mm (PD-TVP2). The elongated TVP fibers were then gently mixed with the PD.

Process of Preparation

Three types of whole meat slabs were printed:

3D-PD-TVP1—PD-TVP1 was printed using an Auger based extruder

3D-PD-TVP2—PD-TVP2 using progressive cavity pump (PCP, Guandong standard fluid systems—dosing screw pump) equipped with 4 mm nozzle. The dispensed strands of PD-TVP2 were aligned in layers using a custom 3D printing jig, such that the strands in each layer had minimal space/distance between neighboring segments of the strand, so as to create a 3D structure with unidirectional of the strands, which was then compacted via vacuuming and formed into a 3D slab structure of about 100 mm*50 mm*50 mm.

3D-PD-TVP3—PD-TVP2 was printed using a piston of an electrical caulking gun (Makita) also equipped with a 4 mm nozzle. The strands were then aligned in layers and placed closely together to form a continues surfaces in each layer, which was then compacted via vacuuming and formed into a 3D slab structure of about 100 mm*50 mm*50 mm.

PD-TVP-PP (Reference)—the product of 3DP-PD-TVP1 was manually disintegrated and kneaded until the anisotropic structure of the 3DP-PD-TVP1 was completely disrupted.

Post-Process Handling
All slabs were cured in Sous Vide @100° C. for 1 h, until internal temperature of the sample reaches and was maintained at 95° C. for 15 minutes. The different slabs were then cooled in a fridge @4° C. overnight before testing. Tests were conducted after samples reached ambient temperature (20° C.-25° C.).
FIGS. 3A-3C are images of 3D-PD-TVP1 manually spliced across a plane parallel to the P axis (scale bar=10 mm). These Figures present the orientation of the essential alignment of the protein-based strands (full arrow) and that partially exposed fibers. It is noted that due to the opacity of both the protein-based dough and the incorporated TVP material, it is difficult to visually demonstrate the fibers' alignment and this is concluded indirectly based on the mechanical analysis of the specimens and of the reference samples, as described below.

Sample Analysis

Shear Resistance Test

To determine shear resistance of the meat alternative, a Lloyd instruments Amtech TA1 test machine was used. Specifically, a blunt metal blade was attached to the Lloyd standard Perspex insertion AACC 16-50 (catalogue number FG/PNB). The blade was in the shape of a trapezoid with the dimensions of—big base 11.81 cm small base of 4.44 cm (see FIG. 6). During the test, the upper fixture with the blade was positioned 25 mm above a metal base and a specimen of the size of 2 cm*2 cm*2 cm (8 cm\hat{ }3) was placed underneath in the desired orientation. Then the upper fixture travels 24 mm downwards at 20 mm/s, so it shears the specimen and reaching 1 mm above the metal base plate. The max load was recorded, and the data was then analyzed and compared between the different specimens and orientations.

Tensile Strength Test

Specimens of 50*20*10 mm were prepared and gripped by rippers made of polylactic acid (PLA), having a contact area of 10*20 mm and operated as shown in FIG. 3A. Then, at room temperature (23° C.±2° C.), each of the specimens (three different samples from each specimen) were stretched at a speed of 20 mm/s. The Modified tensile strength was measured for specimens of 50*20*10 mm (cuts from the printed slab of 10 cm*10 cm).

Table 4A shows results from the tensile strength test analysis of the different tested samples.

TABLE 4A
Modified Tensile Strength Results

| | Tensile, Strength (MPa) | | | | |
|---|---|---|---|---|---|
| | Sam- | Sam- | Sam- | | |
| | ple 1 | ple 2 | ple 3 | average | std |
| PD | 0.014 | 0.008 | 0.014 | 0.012 | 0.0028 |
| PD-TVP-PP | 0.013 | 0.011 | | 0.012 | 0.0013 |
| 3DP PD-TVP1 (XP) | 0.010 | 0.018 | 0.014 | 0.014 | 0.0032 |
| 3DP PD-TVP1 (P) | 0.032 | 0.026 | 0.030 | 0.029 | 0.0027 |
| 3DP PD-TVP2 (XP) | 0.023 | 0.029 | | 0.026 | 0.0028 |
| 3DP PD-TVP2 (P) | 0.040 | 0.039 | | 0.040 | 0.0003 |

The data presented in Table 4 shows that PD and PD-TVP-PP are the weaker samples. With PD-TVP-PP (not printed but rather manually formed into patties), the resulting layer had no organized orientation, and this random orientation of the fibers resulted in a lower tensile strength, when measured from all directions of the samples.

With respect to 3D-PD-TVP1, a difference between the P and XP axes was exhibited. While the strength over the XP axis was comparable to the reference sample PD-TVP-PP, in the P axis, the tensile strength was significantly higher.

It was thus assumed that the improved tensile strength was a result of the fibers' essentially aligned orientation with respect to the P axis and the reinforcement that this orientation provides the printed edible product.

Finally, when using PCP extruder with PD-TVP2, the tensile strength was even further increased and in both the P and XP direction of printing.

The direct conclusion from these results is that the presence of elongated fibers is essential for reinforcing the printed product and that at minimum the product should include some fibers having a length of about 5 mm.

Table 4B shows results from the Shear test analysis of the different tested samples.

TABLE 4B
Modified Shear Test Results

| Custom Shear Test, | Sample | Sample | Sample | aver- | | std |
|---|---|---|---|---|---|---|
| Max Load (N) | 1 | 2 | 3 | age | std | % |
| PD | 3.80 | 3.90 | 6.20 | 4.6 | 1.11 | 23.9 |
| PD-TVP-PP | 12.60 | 5.90 | | 9.3 | 3.35 | 36.2 |
| 3DP PD-TVP1 (P) | 4.62 | 5.36 | 5.13 | 5.0 | 0.31 | 6.1 |
| 3DP PD-TVP1 (XP) | 16.32 | 14.16 | | 15.2 | 1.08 | 7.1 |
| 3DP PD-TVP2 (P) | 6.64 | 5.22 | 4.33 | 5.4 | 0.95 | 17.6 |
| 3DP PD-TVP2 (XP) | 22.54 | 23.37 | | 23.0 | 0.42 | 1.8 |

Table 4B confirms the data from Table 4A in that the dough without TVP is the weakest and that the inclusion of TVP with an amount of elongated fibers (at least 5 mm) improves resistance to shear forces.

Further, the 3D printing resulted in improvement of resistance to shear forces in the P and XP directions, with a much greater resistance in the XP direction.

A better resistance to shear forces was exhibited in the PCP based printed products (3DP PD-TVP2).
These results suggested that the TVP contributes to shear resistance and therefore is expected to contribute to the organoleptic characteristics, such as chewiness. The alignment of the strands and fibers creates a strong anisotropy and strengthen the cross-fiber direction. The use of long TVP fibrous material further contributes to the printed product's strength.

Fibers Analysis

Samples from each of the 3DP examples (30 gr) were collected after printing and before the post treatment (frying or cooking) and placed in a beaker with magnetic stirrer and 200 ml of cold water (10° C.). The samples were spined for 30 min or until the basic protein dough (PD) was visually separated from the TVP and a slurry solution was formed. The slurry solution was then poured over a 1 mm stainless steel sieve (JVLAB test mesh) and then collected, washed again in a beaker with additional 200 ml and filtered again to wash off PD from the TVP fibers until all TVP fibers were clearly visible on the sieve. Then the fibers were mixed with water again and filtered through a system of three sifts with different mesh size, from 1 mm, 2 mm and 3.2 mm, placed one on top of the other such that the slurry is poured over the 3.2 mm sift, and passes to the 2 mm, and thereafter to the 1 mm (last in the pyramid).

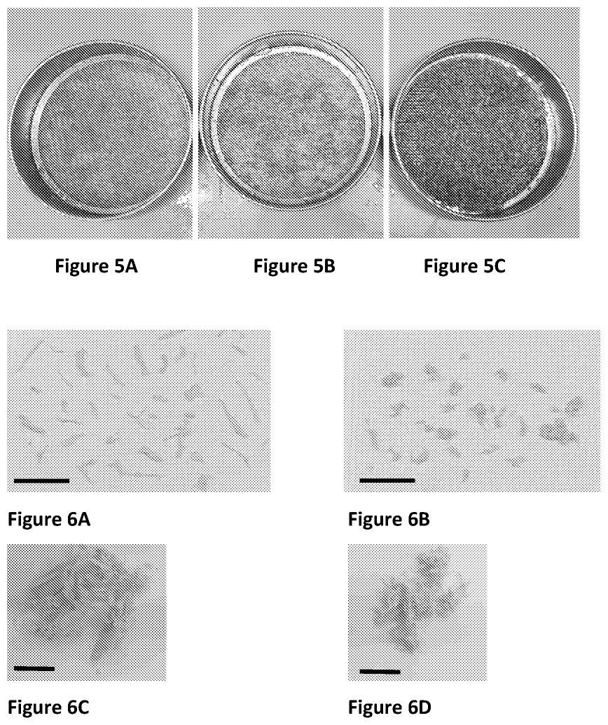

FIGS. 5A-5C show the different sifts after filtration, with FIG. 5A showing the 1 mm mesh sized sift, holding TVP containing material that are 1 mm-2 mm in size, FIG. 5B showing the 2 mm mesh sized sift holding TVP containing material that are 2 mm-3.2 mm in size, and FIG. 8C showing the 3.2 mm mesh sized sift holding TVP containing material that are above 3.2 mm in size.

The sieved matter is squeezed manually to remove excess water. The fibers were imaged and weighed.

FIGS. 6A-6D show images of 3D-PD-TVP1 with two different TVP. Specifically, FIG. 6A and FIG. 5B show the isolated TVP Supermax 5050 and show the TVP fibers before (FIG. 6A) and after (FIG. 6B) printing, while FIG. 6C and FIG. 6D show the isolated TVP A1550 fibers before (FIG. 6C) and after (FIG. 6D) printing using a 5 mm Auger extruder (scale bare being 50 mm).

FIGS. 6A-6D show that the extrusion process using an Auger type printing head resulted in shorter fibers (as compared to their length before printing) and that the overall amount of the elongated fibers that were collected/isolated after filtration was much lower after extrusion (i.e. a elongated fibers were cut during the printing process).

In addition to the qualitative observation the sieved TVP was weighed and it was shown that its retained a fraction over the 3.2 mm sieve was reduced from 27% to 13% due to the extrusion process effect, in other words, there is less of the elongated fibers (those above 3.2 mm in size).

For quantitative determination of the overall amount of TVP-containing fibers, including shorter fibers, a 1 mm sieve can be used.

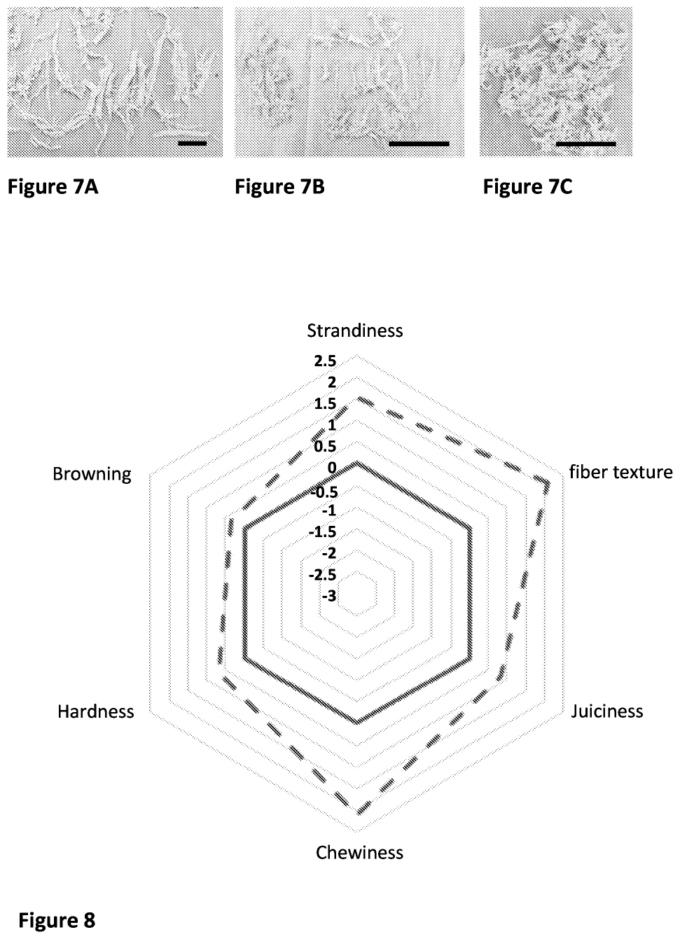

FIGS. 7A-7C show images of fibers isolated from 3D-PD-TVP2 (as described above) before printing (FIG. 7A), after printing with PCP using a 30 mm rotor (FIG. 7B) and after printing using a 20 mm rotor (FIG. 7C).

FIGS. 7A-7C show that using PCP pump is more favorable since it has less impact on the length of the fibers, providing a higher amount of elongated fibers (of about 5 mm and more). It is assumed that the negative impact of the printer head can be reduced when using a longer CP rotor (with a bigger pitch disintegrates the TVP fibers less).

In fact, when using a PCP pump the amount of elongated fibers did not significantly reduce after printing (as compared to the amount before printing, data not shown).

Sensory Panel

The specimens were fabricated 1 day before the panel testing. Thirty minutes before tasting the samples were cut into 2*2*2 cm cubes. Then the samples were fried 90 second on every plane, until reaching 70° C. inside the sample. The samples were served hot to the panel members, in clean plates with their codes on the plates. There were 8 panelists, each panelist received the cooked samples, one from each specimen (3D-PD-TVP1 and 3D-PD-TVP2), and each panelist was asked to rank the specimens for the following characteristics, using a score from −3 to +3, where “0” is assigned to a reference sample made from PD and TVP with the % TVP (Auger print head) used in the preparation being 20% w/w (dry weight to total weight of protein containing material):
Strandiness (visual observation of strands when cracking the specimen)
Fiber texture (the sensory feeling of fibers during oral breakdown)
Juiciness
Chewiness
Hardness
Browning (visual)

The sensory evaluation of 3DP-PD-TVP1 and 3DP-PD-TVP2 is presented in FIG. 8 in the form of a sensory spider diagram.

The spider diagram suggested that the two specimens produced a positive sensory experience, with better/superior organoleptic properties attributed to the 3DP-PD-TVP2.

In a further sensory test, the 8 panelists were given two samples of 3D-PD-TVP differing in the amount of dry TVP, and prepared using Auger printer head and ranked the overall fibrous textural experience using a score of −2 to +2 (“0” being the score for a specimen made using 20% w/w dry TVP). Table 5 shows the ranking:

TABLE 5
effect of percent TVP on fibrous texture experience

| | TVP %* | Fiber texture |
|---|---|---|
| Sample 1 | 10 | −1.6 |
| Sample 2 | 15 | −0.5 |
| Reference | 20 | 0 |

*dry weight to total weight

Table 5 confirms that there is a need for TVP, and preferably in amounts above 10% or even above 15% (dry weight as measured in the protein containing material before printing).

1-35. (canceled)

36. A whole muscle meat substitute, comprising:
one or more layers of digitally printed protein-containing strands;
wherein each layer of the one or more layers comprises a single convoluted strand or a plurality of strands such that segments between folds of the single strand or the plurality of strands are arranged essentially parallel along a longitudinal axis thereof, the single strand or the plurality of strands comprising one or more bundles of axially aligned texturized protein fibers; and
wherein at least a portion of the axially aligned texturized protein fibers comprises elongated fibers having a length above 5 mm.

37. The whole muscle meat substitute of claim 36, wherein at least a portion of the segments between folds of the single strand or of the plurality of strands are interconnected one to a neighboring strand thereof.

38. The whole muscle meat substitute of claim 36, wherein the axially aligned texturized protein fibers within a segment of a strand have a nominal direction that is not more than ±45° from the direction of the segment of the strand when the bundle of axially aligned fibers is viewed from a direction perpendicular to the segment's direction.

39. The whole muscle meat substitute of claim 36, wherein the axially aligned texturized protein fibers within a segment of a strand have a nominal direction that is not more than ±45° from the direction of the segment of the strand when the bundle of axially aligned fibers is viewed from a direction perpendicular to a plane defined by the layer comprising the segment of the strand.

40. The whole muscle meat substitute of claim 36, having a modified tensile strength above 0.02 MPa when measured in a direction parallel to the strand nominal direction.

41. The whole muscle meat substitute of claim 36, having a first modified tensile strength value measured in a P direction that is parallel to the strands nominal direction and a second modified tensile strength value measured in a XP direction that is perpendicular to the strands nominal direction and parallel to a layer's plane, wherein said first modified tensile strength value is at least 50% higher than the second modified tensile strength value.

42. The whole muscle meat substitute of claim 36, having a modified shear resistance above 10N when measured in a P direction that is parallel to the strands' nominal direction.

43. The whole muscle meat substitute of claim 36, having a first modified shear resistance value that is measured in a direction parallel to the strands nominal direction and a second modified shear resistance value that is measured in a direction perpendicular to the strands nominal direction and parallel to a layer's plane, wherein said second modified shear resistance value is at least 100% greater than the first modified shear resistance value.

44. The whole muscle meat substitute of claim 36, further comprising two or more layers of said digitally printed protein-containing strands.

45. The whole muscle meat substitute of claim 44, wherein two or more layers are in interconnected at one or more points along each layer.

46. The whole muscle meat substitute of claim 36, wherein a fat-based component and/or a water-based component are disposed or dispersed in between said digitally printed protein containing strands.

47. The whole muscle meat substitute of claim 46, wherein at least a portion of the one or more layers comprise said fat-based component.

48. A method of producing a meat substitute, the method comprising:
introducing into a printer head of a digital printer protein-containing material; and
operating the digital printer to dispense onto a printer bed a single convoluted protein containing strand or a plurality of individual protein containing strands, the single strand being folded or the plurality of said strands being arranged such that segments between folds of the single strand or the plurality of strands are essentially parallel to each other along their longitudinal axis;
wherein the protein containing strand comprises texturized protein; and
wherein at least a portion of the texturized protein comprises elongated fibers having a length above 5 mm.

49. The method of claim 48, wherein said convoluted strand or the plurality of individual strands form a monolayer.

50. The method of claim 48, wherein said dispensing is operated to allow at least a portion of the segments between folds of the single strand or of the plurality of strands within a monolayer to be interconnected.

51. The method of claim 48, wherein said operating of the digital printer comprises dispensing a single elongated strand of said protein containing material into a horizontal layer such that segments between folds of the single strand in the layer are arranged in an essentially parallel orientation along their longitudinal axis.

52. The method of claim 48, wherein said operating of the digital printer comprises dispensing a plurality of axially aligned contiguous strands.

53. The method of claim 48, further comprising manipulating the dispensed strands or segments of the dispensed strands to interconnect.

54. The method of claim 48, further comprising allowing each layer of dispensed strands to rest prior to applying a subsequent layer thereon.

55. The method of claim 48, further comprising dispensing a plurality of layers of said protein containing strand.
